(19) United States
(12) Patent Application Publication
(10) Pub. No.: US 2014/0109668 A1
(43) Pub. Date: Apr. 24, 2014

(54) Apparatus for a portable clamp-on no spill gauge

(71) Applicant: Kevin J. LARSEN, Northville, MI (US)

(72) Inventor: Kevin J. LARSEN, Northville, MI (US)

(21) Appl. No.: 13/506,941

(22) Filed: May 25, 2012

(51) Int. Cl. G01F 23/58

(52) U.S. Cl. CPC G01F 23/58
USPC 73/322

(57) ABSTRACT

An apparatus and method for detecting when the amount of fluid being filled into a tank reaches a certain predetermined level are provided. The portable no-spill fluid level gauge has a substantially clear cylindrical body with a level indicator near one end. Buoyant members and substantially rigid rod having guides at each end thereof are positioned within the body such that the rod is above the buoyant members. A clamp is attached to the exterior of the body for removably affixing the gauge to the tank's opening such that a portion of the gauge is positioned within the tank. During the filling of the tank with fluid, the fluid flows into the body through openings in the body of the gauge thereby causing the buoyant members to exert an upward force upon the rod through one of the guides and thus move the upper guide towards the level indicator.

### BACKGROUND OF THE INVENTION

1. Field of the Invention

The present invention relates to a portable fluid level indicator gauge. More particularly, the present invention provides a portable no-spill gauge which can be easily clamped onto the fill spout of a fluid tank for accurately detecting when a tank becomes full during re-filling.

2. Description of the Related Art

Devices for determining the liquid level within liquid tanks that are used to contain various substances in a wide range of applications are known. For instance, a liquid level gauge may be permanently installed on the storage tank. However, it is relatively expensive to provide a liquid level gauge in each storage tank when liquid level must be monitored in numerous ones of such tanks. Furthermore, most liquid level gauges are not suitable for use as a portable device because of their intricate design, electrical connections, excessive weight, or mere size. In other words, such gauges cannot be readily transported from one tank to another easily or without risk of damage.

In some cases, rudimentary means are sufficient to determine liquid level, such as the insertion of a measuring rod or dip stick through an opening in the top of the storage tank. The measuring rod is typically graduated, with markings along its length which are indicative of the level of liquid contained in the tank. One end of the rod is initially placed in abutment against the bottom of the storage tank and the rod is then withdrawn. The liquid level is apprised by simply observing how much of the rod is wetted relative to the liquid level markings. However, various problems arise through the use of such a method to measure liquid depth. For example, certain volatile liquids, such as gasoline, tend to evaporate quickly so that the wetted portion of the rod may not be readily observable, especially in poor light. On the other hand, viscous liquids, such as diesel fuel or crude oil, are stable but are not easily wiped or removed from the measuring rod. Moreover, an accurate liquid level measurement is only possible if the measuring rod is manually aligned in a substantially vertical orientation.

More refined approaches for determining liquid level in a storage tank have been developed which utilize portable measuring devices. Although these devices are transportable, they do not have features which allow them to be easily and securely attached to the storage tank. Moreover, the liquid level reference point for these particular devices is the exterior top surface and interior bottom surface of the storage tank, respectively. However, in certain storage tank applications, the liquid level reference point is typically the interior top surface of the tank.

Accordingly, it is recognized that there remains a need for a portable liquid level gauge configured for use with gas powered home equipment, such as lawn mowers, snow throwers, garden tractors, generators and other outdoor/lawn and garden equipment. There is also a need for a portable liquid level gauge having an alligator style spring clamp, made of metal and/or plastic, that is adjustable upward and downward on the device to removably clamp the device to a tank's fill spout at any or a variety of levels, to help prevent liquid fuel from spilling and contaminating the ground while refueling outdoor equipment. The present invention attempts to remedy the problems and drawbacks of prior liquid level gauges, and provides a portable liquid level indicator gauge which easily and securely clamps onto the fill spout of a tank to accurately determine when the level of liquid reach a certain point prior to overflowing.

### SUMMARY OF THE INVENTION

The present invention generally relates to a clamp-on portable liquid level gauge for easily detecting the level of liquid contained in a tank. While the nature of the invention covered herein is to be determined with reference to the claims appended hereto, certain forms of the invention that are characteristic of the preferred embodiment are described briefly as follows.

An apparatus and method are provided for detecting the level of liquid contained in a tank having an interior surface defining a liquid level reference point. According to a typical embodiment, the portable no-spill gauge for detecting when the amount of fluid being inserted into a tank reaches a certain level for preventing overflow of the fluid from the tank comprises: a substantially clear cylindrical body having first and second ends, the body having a level indicator substantially near the first end of the body; one or more buoyant members positioned within the body; at least one substantially rigid rod having a first guide at a first end and a second guide at a second end, the rod being positioned coaxially within the body and above the one or more buoyant members; and a clamp attached to the body for removably affixing the body to a fill spout of a tank for containing a fluid such that a portion of the body is positioned within the tank; wherein upon flow of the fluid into the body through the second end of the body, the one or more buoyant members exert an upward force upon the second guide such that the rigid rod moves upward within the body moving the first guide towards the level indicator. Optionally, the gauge may further comprise one or more openings proximate to the second end of said body to allow fluid to flow into the body.

Also, disclosed is a method for detecting when the amount of fluid being provided into a tank reaches a predetermined level comprising the steps of: providing a portable no-spill fluid level gauge including a substantially clear cylindrical body having first and second ends, the body having a level indicator substantially near the first end of the body, one or more buoyant members positioned within the body, at least one substantially rigid rod having a first guide at a first end and a second guide at a second end, the rod being positioned coaxially within the body and above the one or more buoyant members, and a clamp attached to the body; positioning the level indicator and the clamp in predetermined vertical positions on the body; using the clamp, removably attaching in a substantially vertical configuration the gauge to an opening in the tank such that the second end of the body is positioned within the tank; upon flow of fluid into the body through the second end of the body vertically displacing the buoyant members and the rod; and observing the first guide within the body to detect when the first guide reaches the level indicator to determine that the fluid in the tank has reached a predetermined level.

Moreover, the no-spill gauge according to the invention may also include at the first and second ends of the body stops to retain the buoyant members and rod within the body. It may also include an adjustment handle for adjusting the position of the level indicator on the body with respect to the clamp, where the adjustment handle comprises two plastic handles attached to a round spring clamp, with the round spring clamp being positioned around the body such that the adjustment handle is releasable by pressing first and second arms inward toward each other to open the round spring clamp. The gauge may also optionally include a full marker positioned on the body at a point indicating a level where the tank is full of fluid, the full marker being connected to the level indicator and the adjustment handle by a connecting arm such that the full marker is repositioned when the adjustment handle is repositioned. Optionally, the no-spill level gauge may comprise a pointer for indicating when the first end of the rod reaches the level indicator. Moreover, the clamp may be adjustable upward and downward on the body, and the buoyant members may be round cork balls and may move independently from one another and spin freely as they move within the body.

It is an object of the present invention to provide an apparatus and method for accurately detecting the level of liquid contained within a tank during filling or re-filling of the tank with a liquid.

Another object of the present invention is to provide an easily and readily portable clamp-on no-spill gauge which is releasably attached to the fill spout of a tank.

It is another object of the invention to provide a no-spill gauge designed for use with lawn mowers, snow throwers, garden tractors, generators and other outdoor/lawn and garden equipment.

It is another object of the invention to provide a no-spill gauge suitable for use on different types of outdoor equipment.

It is another object of the invention to provide a no-spill gauge having a clip made of an alligator style spring clamp, made of metal and plastic, that adjusts up and down on the gauge and is used to clamp the gauge to a tank's fill spout.

It is another object of the invention to provide a no-spill gauge that is open at the top and bottom with small holes drilled in the gauge near the bottom and “V” shaped notches in the bottom to allow liquid to freely flow into the gauge.

It is another object of the invention to provide a no-spill gauge that can be manufactured in different lengths and different sizes with varying number of Floats to work in a large variety of situations.

It is another object of the invention to provide a no-spill gauge that has multiple, individual round floats. Such a design uses floats that are preferably made of round cork balls of approximately 5/16 inch in diameter, which are preferably not connected to each other or to the riser arm. Such a design allows the floats to move independently and spin freely as they rise in the gauge. This design virtually eliminates any sticking or binding as the floats move upward in the gauge.

It is another object of the invention to provide a no-spill gauge that has a light weight single wire rising arm with double triangle guides at each end. Such a design minimizes friction as the rising arm moves up in the gauge.

It is another object of the invention to provide a no-spill gauge designed to help prevent gasoline and diesel fuel from spilling and contaminating the ground while fueling outdoor equipment in order to minimize waste of the liquid and help lower the amount of pollution and contamination produced by lawn and garden and landscape equipment each year.

It is another object of the invention to provide a no-spill gauge that has an adjustment handle having two plastic handles attached to a plastic covered round metal spring clamp. The round spring clamp is positioned around the outside of the gauge and is used as the full indicator. The adjustment handle is preferably connected to the full indicator and the connector arm to hold the full indicator and full marker securely in place on the gauge. The adjustment handle may optionally be configured such that it may be released with finger tips by pressing the adjustment handles inward toward each other to loosen the round spring clamp to adjust the full marker and full indicator upward or downward on the gauge so the gauge can be used with devices having different size tanks and fill spouts.

It is another object of the invention to provide a no-spill gauge that is compact and portable, and is entirely self-contained such that it can fit easily into a toolbox or other carrying case.

It is another object of the invention to provide a no-spill gauge that can be used with or without a funnel.

It is another object of the invention to provide a no-spill gauge that is simple and easy to use by a homeowner or on a jobsite by a professional.

It is another object of the invention to provide a no-spill gauge that is configured such that the full indicator and full marker are adjustable to accommodate different desired filling levels.

It is another object of the invention to provide a no-spill gauge that saves money by preventing costly fuel spills and increases efficiency by filling the tank completely full every time.

It is another object of the invention to provide a no-spill gauge that saves time by allowing a person to fill the tank in a single pour without stopping intermittently to check the fluid level within the tank.

It is another object of the invention to provide a no-spill gauge that is manufactured with no exposed metal parts on its exterior to help minimize the occurrence of an accidental spark.

The above and other aspects, features and advantages of the present invention will be apparent to those skilled in the art upon consideration of the following description read in conjunction with the accompanying drawings, in which like reference numerals designate the same elements.

### BRIEF DESCRIPTION OF THE DRAWINGS

A further understanding of the present invention can be obtained by reference to a preferred embodiment set forth in the illustrations of the accompanying drawings. Although the illustrated preferred embodiment is merely exemplary of methods, structures and compositions for carrying out the present invention, both the organization and method of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the invention.

For a more complete understanding of the present invention, reference is now made to the following drawings in which:

FIG. 1 shows an exposed side elevation view of the no-spill gauge in accordance with the preferred embodiment of the present invention;

FIG. 2 shows an exposed side elevation view of the no-spill gauge depicted in FIG. 1 positioned in a fluid tank and indicating a full tank of fluid;

FIG. 3A shows an exposed side elevation view of the no-spill gauge depicted in FIG. 1 positioned in a fluid tank and indicating an empty tank of fluid;

FIG. 3B shows an exposed side elevation view of the no-spill gauge depicted in FIG. 1 positioned in a fluid tank and indicating a full tank of fluid;

FIG. 4A shows an exposed side elevation view of the no-spill gauge depicted in FIG. 1 showing the clip in a lower position on the gauge;

FIG. 4B shows an exposed side elevation view of the no-spill gauge depicted in FIG. 1 showing the clip in a different, higher position on the gauge;

FIG. 5A shows an exposed side elevation view of the no-spill gauge depicted in FIG. 1 showing the full indicator and full marker in a lower position on the gauge;

FIG. 5B shows an exposed side elevation view of the no-spill gauge depicted in FIG. 1 showing the full indicator and full marker in a different, higher position on the gauge;

FIG. 6A shows a partial perspective and enlarged view of a portion of the no-spill gauge depicted in FIG. 1 showing the adjustment handle in a secured position holding the full indicator and full marker securely in place on the gauge;

FIG. 6B shows a partial perspective and enlarged view of a portion of the no-spill gauge depicted in FIG. 1 showing the adjustment handle in a released position, with its handles pushed together, allowing the full indicator and full marker to be moved up or down along the length of the gauge; and

FIG. 7 shows an enlarged perspective view of the riser arm guides for use with the no-spill gauge according to the invention.

### DETAILED DESCRIPTION OF THE PREFERRED EMBODIMENTS

As required, a detailed illustrative embodiment of the present invention is disclosed herein. However, techniques, systems, compositions and operating structures in accordance with the present invention may be embodied in a wide variety of sizes, shapes, forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein which define the scope of the present invention.

Reference will now be made in detail to several embodiments of the invention that are illustrated in the accompanying drawings. Wherever possible, same or similar reference numerals are used in the drawings and the description to refer to the same or like parts or steps. The drawings are in simplified form and are not to precise scale. For purposes of convenience and clarity only, directional terms, such as top, bottom, up, down, over, above, below, etc., or motional terms, such as forward, back, sideways, transverse, etc. may be used with respect to the drawings. These and similar directional terms should not be construed to limit the scope of the invention in any manner.

### LISTING OF PARTS

Stops 1—The stops 1 are made of wire. The stops 1 are located at the top and bottom of the tube and are designed to keep the moving parts inside the gauge.

Full Indicator 2—The full indicator 2 is made of plastic. The full indicator 2 is adjustable and moves in conjunction with the full marker 10. The full indicator 2 is bright color and is clearly visible above the tank fill spout 16. When the rising pointer 5 reaches the full indicator 2 the tank 17 is full to the full marker 10 inside the tank 17.

Adjustment Handle 3—The adjustment handle 3 has two plastic handles attached to a plastic covered round metal spring clamp. The round spring clamp goes around the outside of the gauge. The plastic covered round spring clamp is also used as the full indicator 2. The adjustment handle 3 is connected to the full indicator 2 and the connector arm 7. The adjustment handle 3 holds the full indicator 2 and full marker 10 securely in place on the gauge. The adjustment handle 3 can be released with finger tips by pressing the adjustment handles inward toward each other to loosen the round spring clamp to adjust the full marker 10 and full indicator 2 up and down on the gauge.

Tube or body 4—The tube or body 4 is clear, chemical resistant rigid plastic, 13″ long×⅜″ inside diameter×½″ outside diameter. The floats 12, rising arm 11 and rising pointer 5 move freely inside the tube. The clip or clamp 9, full marker 10 and full indicator 2 are adjustable and move on the outside of the tube 4. The tube 4 is open at the top and bottom, with small holes drilled in the tube 4 near the bottom. Small stops 1 are positioned at each end of the tube 4 to keep the moving parts inside the tube 4.

Rising Pointer 5—The rising pointer 5 is made of brightly colored light weight foam. The rising pointer 5 is located on the top of the riser arm 11. The rising pointer 5 is clearly visible as it rises up in the gauge. The closer the rising pointer 5 gets to the full indicator 2, the closer the tank 17 gets to being full. When the rising pointer 5 reaches the full indicator 10 the tank 17 is completely full.

Riser Arm Guides 6—There are riser arm guides 6 at each end of the riser arm 11. The riser arm guides 6 are made of a single copper wire that is formed into two perpendicular triangular shapes, which forms an “X” shape at each end of the riser arm 11. This design minimizes the surface area of wire that touches the gauge walls. This virtually eliminates any sticking or binding as the riser arm 11 moves up in the gauge.

Connector Arm 7—The connector arm 7 is made of plastic. The full marker 10 and the full indicator 2 are connected to each other by the connecting arm 7.

Clip Adjustment Handle 8—The clip adjustment handle 8 is made of two plastic handles attached to a plastic covered round metal spring clamp. The clip adjustment handle 8 is attached to the clip 9. The round spring clamp goes around the outside of the gauge. The clip adjustment handle 8 holds the clip 9 firmly in place on the gauge. The clip adjustment handle 8 has a finger tip release for adjusting the clip, up and down on the gauge.

Clamp or clip 9—The clip or clamp 9 is an alligator type spring clamp made of metal and plastic. The clip 9 adjusts up and down on the gauge and is used to clamp the gauge to a tank's fill spout 16.

Full Marker 10—The full marker 10 is made of plastic. The full marker 10 is adjustable and moves in conjunction with the full indicator 2. The full marker 10 is placed inside the tank and set to the desired full liquid level. The full marker 10 is a bright color and visible even in low light.

Riser Arm or Rod 11—The riser arm 11 is made of a single copper wire. The wire is formed into riser arm guides 6 at each end of the arm 11. The riser arm 11 is pushed up in the gauge by the rising floats 12. The riser arm 11 has the bright colored rising pointer 6 positioned at the top end to clearly indicate when the tank 17 is full.

Floats or Buoyant members 12—The floats 12 are made of 5/16″ round cork balls. The balls 12 are not connected to each other or to the riser arm 11. This allows the floats 12 to move independently and spin freely as they rise in the gauge. This design virtually eliminates any sticking or binding as the floats 12 move up in the gauge. The floats 12 move up in the gauge as the liquid rises in the tank 17. When the floats 12 rise to the full marker 10 within the tank 17, the rising pointer 5 will reach the full indicator 2.

Openings or Holes 13—Small holes 13 near the bottom of the tube 4 help ensure liquid flows freely into the gauge.

Notches 14—Small “V” shaped notches 14 at the bottom of the gauge help ensure liquid flows freely into the gauge.

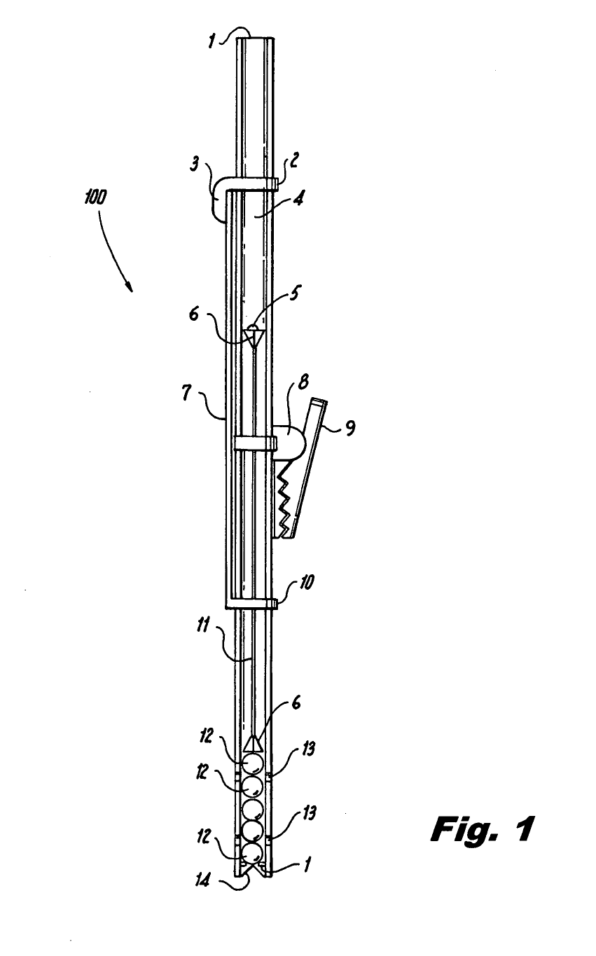

Referring first to FIG. 1, shown is an exposed side elevation view of the no-spill gauge 100 in accordance with the preferred embodiment of the present invention in a pre-installation configuration. Gauge 100 generally includes a tube or body 4, level or full indicator 2, adjustment handle 3, connector arm 7, clamp or clip 9 having clamp adjustment handle 8, full marker 10, riser arm or rod assembly 11 having riser arm guides 6 and optionally rising pointer 5, floats or buoyant members 12 and openings or holes 13.

Tube or body 4 is an elongate tube defining a longitudinal axis having opposing ends. Tube 4 has an opening extending therethrough in a longitudinal direction. As depicted, tube 4 has a generally circular cross section. However, it should be understood that tube 4 can take on other cross sections as well, such as, for example, a square or polygonal configuration. The tube or body 4 is preferably a clear, chemical resistant rigid plastic. Preferably, tube 4 is approximately 13″ long with a ⅜″ inside diameter and a ½″ outside diameter, although it will be appreciated that the invention can be configured in a variety of different sizes. Positioned inside of tube 4 are floats 12, riser arm or rod 11 with riser guides 6 and rising pointer 5, all of which are configured so as to move freely longitudinally inside of tube 4. As shown, floats 12 are positioned below rod assembly 11. The clip or clamp 9, full marker 10 and full indicator 2 are movably attached to the exterior of tube 4, and are adjustable to move longitudinally on the outside of the tube 4. Preferably tube 4 is open at both ends, and has one or more small holes 13 in the side of tube 4 near its bottom end. Small stops 1 are positioned at each end of the tube 4 on the interior of tube 4 to keep the moving parts (i.e., floats 12 and rod 11 with guides 6) inside of tube 4.

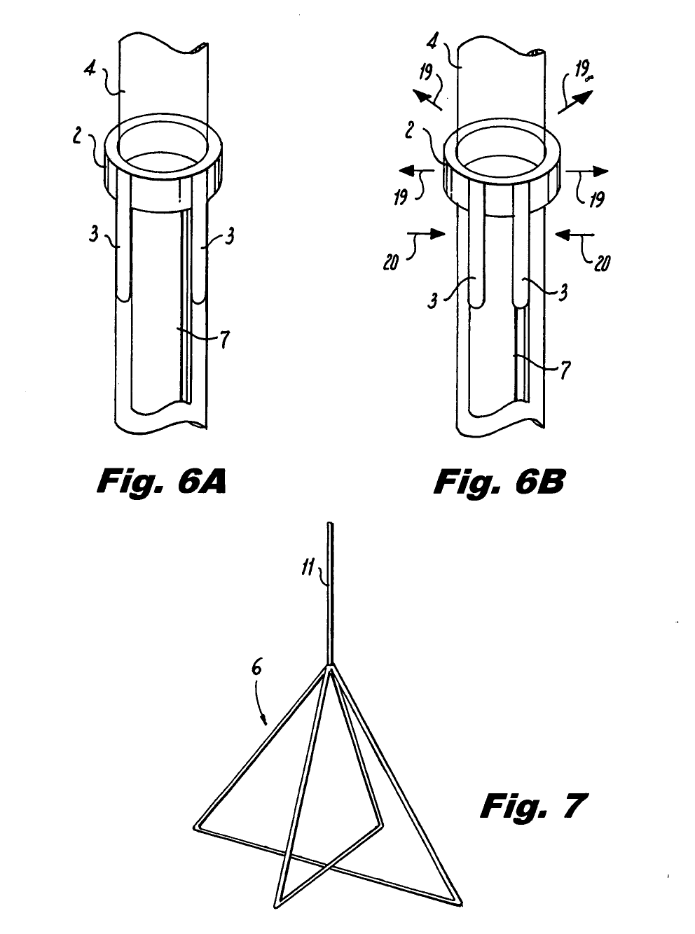

Preferably, on the exterior of tube 4 are full indicator 2, adjustment handle 3, connector arm 7, clamp or clip 9 having clamp adjustment handle 8, and full marker 10. The full indicator 2 is preferably made of plastic, but may be made of other known durable materials. The full indicator 2 is connected to the full marker 10 by connector arm 7 so that they are adjustable by the adjustment handle 3 so as to move in conjunction with one another in a longitudinal direction along the exterior of tube 4. The adjustment handle 3, as shown more clearly in FIGS. 6A-B, preferably has two plastic handles attached to a plastic covered round metal spring clamp. The plastic covered round spring clamp is also used as the full indicator 2, and preferably encircles the outside of the tube 4. The adjustment handle 3 is connected to the full indicator 2 and the connector arm 7, and holds the full indicator 2 and full marker 10 securely in place on the tube 4. During adjustment of the position of full indicator 2 and full marker 10, the adjustment handle 3 is released with finger tips by pressing the adjustment handles in an inward direction 20 toward each other to open the round spring clamp 2 in an outward direction 19 so full marker 10 and full indicator 2 may be moved up or down on the tube 4. Optionally, the full indicator 2 is a bright color so as to be clearly visible above the tank fill spout 16.

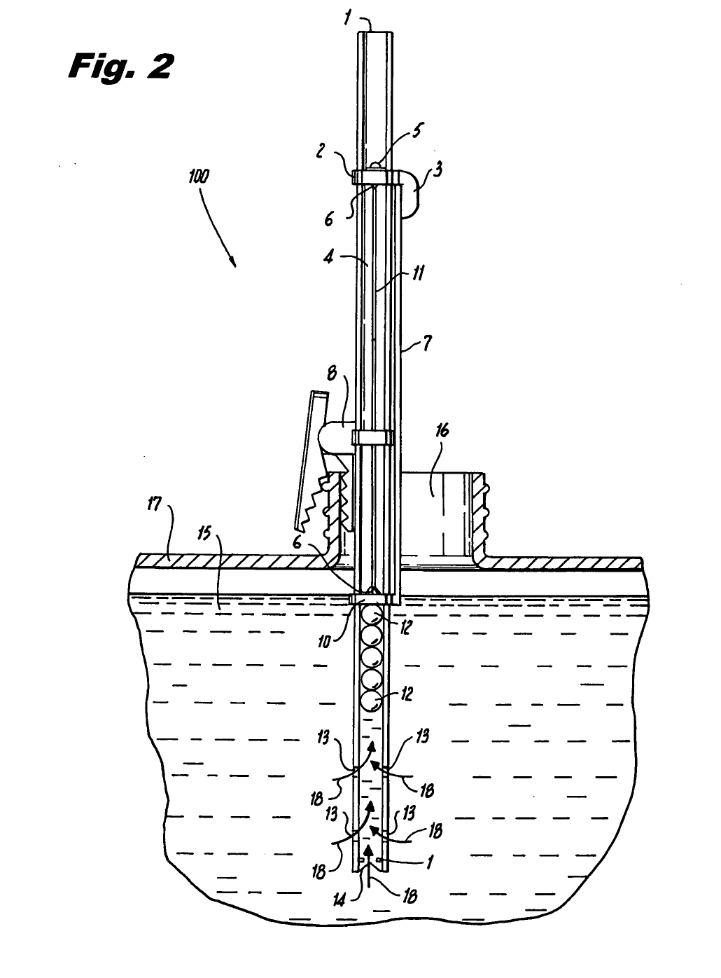

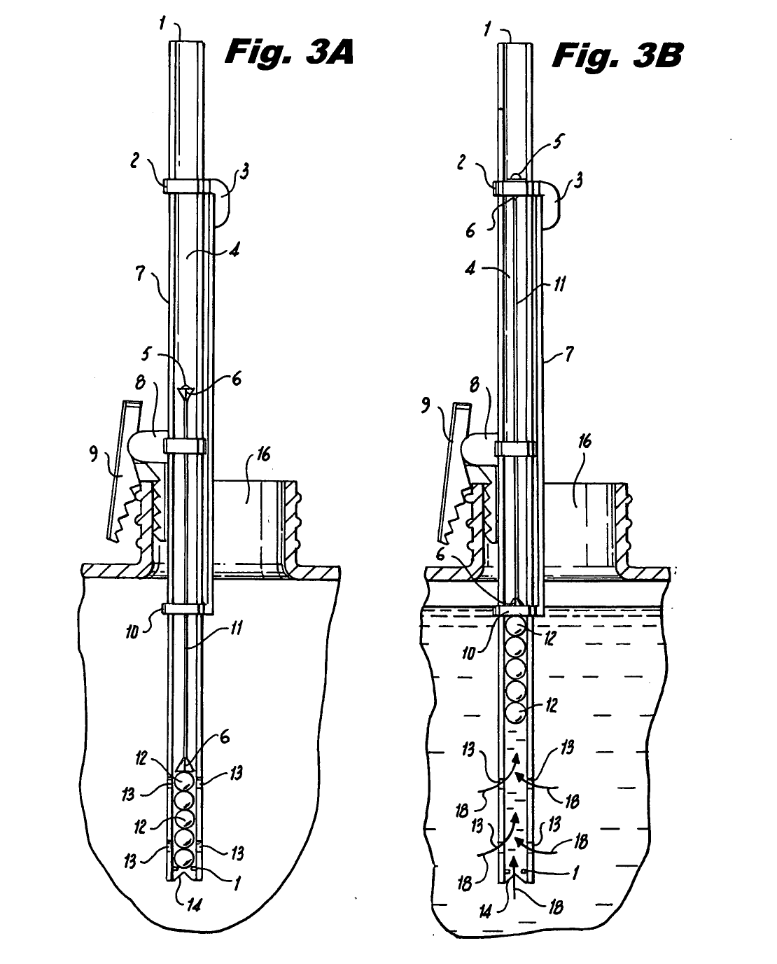

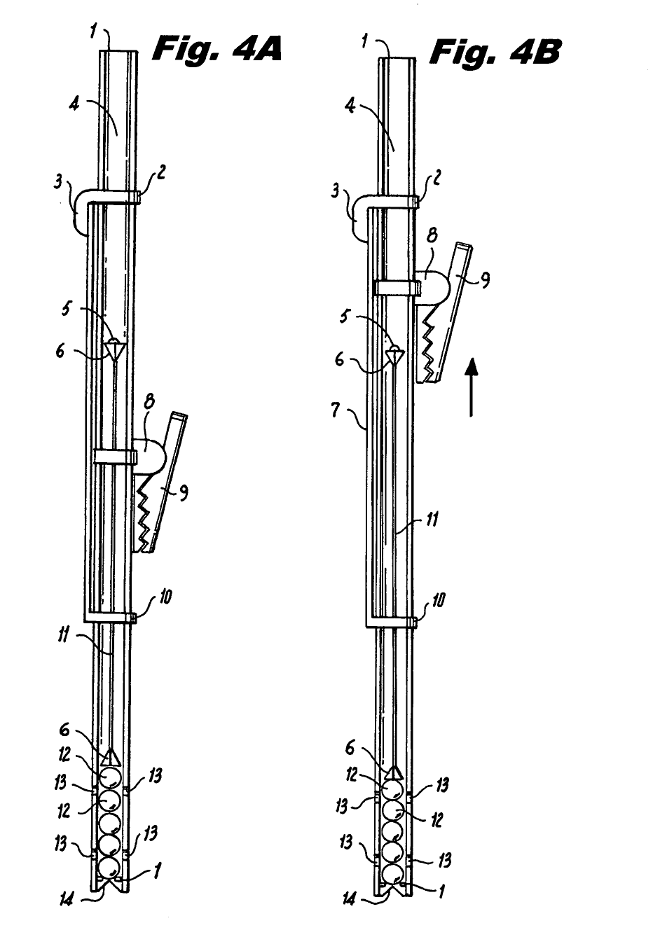

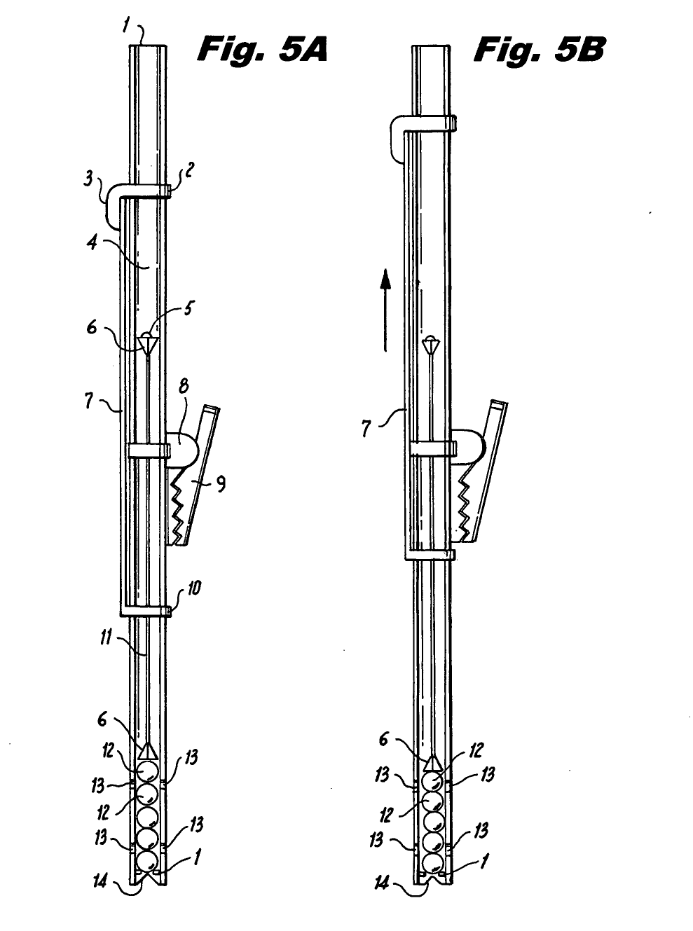

Preferably, the full marker 10, full indicator 2, and connector arm 7 are made of plastic. The full marker 10 and the full indicator 2 are connected to each other by the connector arm 7. The full marker 10 is placed inside the tank and set to the desired full liquid level. The full marker 10 is a bright color and visible even in low light. Also, positioned on the exterior of tube 4 are clip or clamp 9 with clip adjustment handle 8. Clip adjustment handle 8 is preferably made of two plastic handles attached to a plastic covered round metal spring clamp. The clip adjustment handle 8 is attached to the clip 9 and the round spring clamp encircles the outside of tube 4. The clip adjustment handle 8 holds the clip 9 firmly in place on the tube 4 until the user desires to reposition the clip 9. The clip adjustment handle 8 has a finger tip release similar to that described above for adjustment handle 3 so as to enable adjustment of the clip 9 up or down on the tube 4. The clip or clamp 9 is preferably an alligator type spring clamp made of metal and plastic. However, other known types of clips or clamps may be utilized with the invention. The clip 9 is adjustable upward and downward on the gauge 100 and is used to clamp or releasably affix the gauge 100 to a tank's fill spout 16, as depicted in FIG. 2 and FIGS. 3A-B.

Again referring to FIGS. 2 and 3A-B, when fluid is inserted into a tank 17 having gauge 100 releasably affixed to its fill spout 16, the fluid enters the interior or tube 4 through one or more openings 13 as well as through the opening at the bottom of tube 4 as indicated by arrows 18. As the fluid fills up inside of tank 17, the level of fluid inside of tube 4 rises along with the level of fluid in tank 17. As the fluid rises inside of tube 4, floats or buoyant members 12 rise within tube 4 thereby exerting an upward force upon the bottom guide 6 or riser arm or rod assembly 11. The floats or buoyant members 12 are preferably made of 5/16″ round cork balls, although other similar buoyant material may be used. Of course, alternatively shaped buoyant members may be used depending on the shape and size of tube 4. The floats or buoyant members 12 are preferably not connected to one another or to the bottom guide 6 of riser arm 11. This allows the floats 12 to move independently and spin freely as they rise within tube 4. This design substantially eliminates any sticking or binding as the floats 12 move up in the tube 4. The floats 12 move up in the gauge 100 as the liquid rises in the tank 17 such that when the floats 12 rise to the full marker 10 within the tank 17, the rising pointer 5 will simultaneously reach the full indicator 2 to indicate that the fluid level in tank 17 will have reached the full marker 10 positioned inside the tank 17.

Riser arm or rod assembly 11 is preferably made of a single rigid wire, such as copper or some other similar material. At each end, the wire is formed into separate riser arm guides 6. As seen more clearly in FIG. 7, riser arm guides 6 generally take the shape of two substantially perpendicular triangles, which when viewed from the top or bottom generally forms an “X” shape at each end of the riser arm 11. This design minimizes the surface area of wire that touches the inner walls of tube 4. This substantially eliminates any sticking or binding as the riser arm 11 moves upward within the gauge 100. The riser arm assembly 11 optionally has a bright colored rising pointer 6 positioned at the top end to clearly indicate when it reaches full indicator 2. The rising pointer 5 is made of brightly colored light weight foam, although it may be constructed of other similar light weight materials. The rising pointer 5 is preferably located on the top of the riser arm 11 such that it is clearly visible as it rises up in the tube 4. The closer the rising pointer 5 gets to the full indicator 2, the closer the tank 17 gets to being full. When the rising pointer 5 reaches the full indicator 10 the tank 17 is full.

When in its pre-installation configuration (FIG. 1), gauge 100 may be inserted in tank 17 via fill spout 16. As shown in FIGS. 2 and 3A-B, the cylindrical collar of fill spout 16 includes an exterior portion extending outwardly from the wall of tank 17 and is oftentimes threaded for closure with a cap. Additionally, the collar defines substantially vertical inner and outer surfaces. The lower portion of gauge 100 is inserted through the opening in fill spout 16, far enough so that the full marker 10 is positioned below the level of where the collar of fill spout 16 meets the wall of tank 17. As gauge 100 is being inserted into tank 17 through fill spout 16, clamp or clip 9 is opened such that it clamps onto or is releasably affixed to the cylindrical collar of fill spout 16.

After gauge 100 has been releasably attached to tank 17, the user may then begin to fill or refill tank 17. With tube 4 aligned in a substantially vertical orientation, and securely positioned in a predetermined perpendicular position relative to the liquid level of tank 17, the fluid contents of tank 17 can be readily detected by directly observing the upper end of clear tube 4 at or around level or full indicator 2 and riser pointer 5 within tube 4. As liquid 15 is added to tank 17, rod assembly 11 will be vertically displaced in response to a corresponding change in liquid level. Again, the amount of liquid 15 contained in tank 17 can be instantaneously detected by directly observing rising pointer 5 in tube 4 in relation to full indicator 2.

In the claims, means or step-plus-function clauses are intended to cover the structures described or suggested herein as performing the recited function and not only structural equivalents but also equivalent structures. Thus, for example, although a nail, a screw, and a bolt may not be structural equivalents in that a nail relies on friction between a wooden part and a cylindrical surface, a screw's helical surface positively engages the wooden part, and a bolt's head and nut compress opposite sides of a wooden part, in the environment of fastening wooden parts, a nail, a screw, and a bolt may be readily understood by those skilled in the art as equivalent structures.

Having described at least one of the preferred embodiments of the present invention with reference to the accompanying drawings, it is to be understood that such embodiments are merely exemplary and that the invention is not limited to those precise embodiments, and that various changes, modifications, and adaptations may be effected therein by one skilled in the art without departing from the scope or spirit of the invention as defined in the appended claims. The scope of the invention, therefore, shall be defined solely by the following claims. Further, it will be apparent to those of skill in the art that numerous changes may be made in such details without departing from the spirit and the principles of the invention. It should be appreciated that the present invention is capable of being embodied in other forms without departing from its essential characteristics.

What is claimed is:

1. A portable no-spill gauge for detecting when the amount of fluid being inserted into a tank reaches a certain level for preventing overflow of the fluid from the tank, wherein said gauge comprises:
a substantially clear cylindrical body having first and second ends, said body having a level indicator substantially near said first end of said body;
one or more buoyant members positioned within said body;
at least one substantially rigid rod having a first guide at a first end and a second guide at a second end, said rod being positioned coaxially within said body and above said one or more buoyant members; and
a clamp attached to said body for removably affixing said body to a fill spout of a tank for containing a fluid such that a portion of said body is positioned within said tank;
wherein upon flow of said fluid into said body through said second end of said body, said one or more buoyant members exert an upward force upon said second guide such that said rigid rod moves upward within said body moving said first guide towards said level indicator.

2. The gauge of claim 1, wherein said body further comprises one or more openings proximate to said second end of said body to allow fluid to flow into said body.

3. The gauge of claim 1, wherein each of said first and second ends of said body comprises stops to retain said one or more buoyant members and said rod within said body.

4. The gauge of claim 1, wherein said gauge further comprises:
an adjustment handle for adjusting the position of said level indicator on said body with respect to said clamp.

5. The gauge of claim 4, wherein said adjustment handle comprises two plastic handles attached to a round spring clamp, said round spring clamp being positioned around said body such that said adjustment handle is releasable by pressing first and second arms inward toward each other to open said round spring clamp.

6. The gauge of claim 5, wherein said gauge further comprises a full marker positioned on said body at a point indicating a level where said tank is full, said full marker being connected to said level indicator and said adjustment handle by a connecting arm such that said full marker is repositioned when said adjustment handle is repositioned.

7. The gauge of claim 1, wherein said first guide further comprises a pointer for indicating when said first end of said rod reaches said level indicator.

8. The gauge of claim 1, wherein said clamp is adjustable upward and downward on said body.

9. The gauge of claim 1, wherein said buoyant members are round cork balls.

10. The gauge of claim 1, wherein said buoyant members move independently from one another and spin freely as they move within said body.

11. A method for detecting when the amount of fluid being provided into a tank reaches a predetermined level, the method comprising the steps of:
providing a portable no-spill fluid level gauge including:
a substantially clear cylindrical body having first and second ends, said body having a level indicator substantially near said first end of said body;
one or more buoyant members positioned within said body;
at least one substantially rigid rod having a first guide at a first end and a second guide at a second end, said rod being positioned coaxially within said body and above said one or more buoyant members; and
a clamp attached to said body;
positioning said level indicator and said clamp in predetermined vertical positions on said body;
using said clamp, removably attaching in a substantially vertical configuration said gauge to an opening in said tank such that said second end of said body is positioned within said tank;
upon flow of said fluid into said body through said second end of said body vertically displacing said buoyant members and said rod; and
observing said first guide within said body to detect when said first guide reaches said level indicator to determine that said fluid in said tank has reached a predetermined level.

12. The method of claim 11, wherein said body further comprises one or more openings proximate to said second end of said body to allow fluid to flow into said body.

13. The method of claim 11, wherein each of said first and second end of said body comprises stops to retain said one or more buoyant members and said rod within said body.

14. The method of claim 11, wherein said gauge further comprises:
an adjustment handle for adjusting the position of said level indicator on said body with respect to said clamp.

15. The method of claim 14, wherein said adjustment handle comprises two plastic handles attached to a round spring clamp, said round spring clamp being positioned around said body such that said adjustment handle is releasable by pressing first and second arms inward toward each other to open said round spring clamp.

16. The method of claim 15, wherein said gauge further comprises a full marker positioned on said body at a point indicating a level where said tank is full, said full marker being connected to said level indicator and said adjustment handle by a connecting arm such that said full marker is repositioned when said adjustment handle is repositioned.

17. The method of claim 11, wherein said first guide further comprises a pointer for indicating when said first end of said rod reaches said level indicator.

18. The method of claim 11, wherein said clamp is adjustable upward and downward on said body.

19. The method of claim 11, wherein said buoyant members are round cork balls.

20. The method of claim 11, wherein said buoyant members move independently from one another and spin freely as they move within said body.
